(19) United States
(12) Patent Application Publication
(10) Pub. No.: US 2025/0088863 A1
(43) Pub. Date: Mar. 13, 2025

(54) FREQUENCY BAND SHARING TECHNIQUES

(71) Applicant: QUALCOMM Incorporated, San Diego, CA (US)

(72) Inventors: Aleksandar DAMNJANOVIC, Del Mar, CA (US); Tingfang JI, San Diego, CA (US); Krishna Kiran MUKKAVILLI, San Diego, CA (US)

(21) Appl. No.: 18/815,629

(22) Filed: Aug. 26, 2024

Related U.S. Application Data
(60) Provisional application No. 63/582,487, filed on Sep. 13, 2023.

(51) Int. Cl. H04W 16/14

(52) U.S. Cl. CPC H04W 16/14

(57) ABSTRACT

Methods, systems, and devices for wireless communications are described. A user equipment (UE) may receive an indication of one or more rules for wireless communications on an outdoor network deployment using a licensed spectrum that includes an overlapping frequency band with respect to an unlicensed spectrum used for wireless communications on an indoor network, wherein the one or more rules facilitate coexistence between the indoor network and the outdoor network deployment. The UE may perform the wireless communications on the outdoor network deployment in accordance with the one or more rules.

### CROSS REFERENCE

The present Application for Patent claims the benefit of U.S. Provisional Patent Application No. 63/582,487 by DAMNJANOVIC et al., entitled “FREQUENCY BAND SHARING TECHNIQUES,” filed Sep. 13, 2023, assigned to the assignee hereof, and expressly incorporated by reference herein.

### FIELD OF TECHNOLOGY

The present disclosure relates to wireless communications, including frequency band sharing techniques.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support frequency band sharing techniques. For example, the described techniques provide for coexistence for a frequency band allocated to different deployment scenarios. For example, the frequency band may be allocated to an unlicensed spectrum for indoor deployment scenarios. The indoor deployment of the unlicensed spectrum may utilize a time-based duplexing scheme (e.g., time division duplexing (TDD)). The frequency band may also be allocated to a licensed spectrum for outdoor deployment scenarios. The outdoor deployment of the licensed spectrum may, in contrast, use a frequency-based duplexing scheme (e.g., frequency division duplexing/subband full-duplex (FDD/SBFD)). Thus, the outdoor network may overlap with respect to the indoor network. In some examples, the network entity may access the licensed spectrum in the outdoor deployment without performing a listen-before-talk (LBT) procedure. The user equipment (UE) may use the LBT procedure when accessing the licensed spectrum in the outdoor deployment.

A method for wireless communications by a UE is described. The method may include receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment and performing the wireless communications on the outdoor network deployment in accordance with the one or more rules.

A UE for wireless communications is described. The UE may include one or more memories storing processor executable code, and one or more processors coupled with the one or more memories. The one or more processors may individually or collectively operable to execute the code to cause the UE to receive an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment and perform the wireless communications on the outdoor network deployment in accordance with the one or more rules.

Another UE for wireless communications is described. The UE may include means for receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment and means for performing the wireless communications on the outdoor network deployment in accordance with the one or more rules.

A non-transitory computer-readable medium storing code for wireless communications is described. The code may include instructions executable by a processor to receive an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment and perform the wireless communications on the outdoor network deployment in accordance with the one or more rules.

In some examples of the method, UEs, and non-transitory computer-readable medium described herein, the outdoor network using the licensed spectrum comprises at least one of a TDD network, a FDD network, or a SBFD network.

In some examples of the method, UEs, and non-transitory computer-readable medium described herein, a first subband of the SBFD network is used for uplink communications based on a LBT procedure and a second subband of the SBFD network is used for downlink communications without the LBT procedure.

In some examples of the method, UEs, and non-transitory computer-readable medium described herein, the indoor network using the unlicensed network comprises a different TDD network where the UE is in a non-connected state.

In some examples of the method, user equipment (UEs), and non-transitory computer-readable medium described herein, performing the wireless communications on the outdoor network deployment may include operations, features, means, or instructions for performing a LBT procedure prior to transmitting to the outdoor network deployment, in accordance with the one or more rules.

Some examples of the method, UEs, and non-transitory computer-readable medium described herein may further include operations, features, means, or instructions for determining that the wireless communications on the outdoor network deployment may be time division duplexed to include uplink transmission time durations and downlink transmission time durations, and where the LBT procedure, in accordance with the one or more rules, occurs prior to wireless communications during the uplink transmission time durations but not prior to wireless communications during the downlink transmission time durations.

Some examples of the method, UEs, and non-transitory computer-readable medium described herein may further include operations, features, means, or instructions for determining that the wireless communications on the outdoor network deployment may be associated with a first subband of the overlapping frequency band and a second subband of the overlapping frequency band, where the first subband may be allocated for uplink communications and the second subband may be allocated for downlink communications, where the LBT procedure may be based on the first subband in accordance with the one or more rules.

In some examples of the method, UEs, and non-transitory computer-readable medium described herein, the LBT procedure may be based on the UE, in accordance with the one or more rules.

Some examples of the method, UEs, and non-transitory computer-readable medium described herein may further include operations, features, means, or instructions for determining that the wireless communications on the outdoor network deployment may be associated with a first subband of the overlapping frequency band and a second subband of the overlapping frequency band, where the first subband may be allocated for wireless communications that do not require the LBT procedure, and the second subband may be allocated for wireless communications that do require the LBT procedure.

In some examples of the method, UEs, and non-transitory computer-readable medium described herein, the first subband may be allocated for clear channel assessment (CCA)-exempt transmissions (CETs) by the UE.

In some examples of the method, UEs, and non-transitory computer-readable medium described herein, the first subband may be allocated for exclusive use within the licensed spectrum.

In some examples of the method, UEs, and non-transitory computer-readable medium described herein, the first subband may be allocated for CETs by a network entity and for one or more types of duty cycle transmissions of the UE.

In some examples of the method, UEs, and non-transitory computer-readable medium described herein, the second subband may be allocated to require the LBT procedure for any transmission over the second subband.

In some examples of the method, UEs, and non-transitory computer-readable medium described herein, the second subband may be allocated for a limited use of CETs by UEs and network entities.

In some examples of the method, UEs, and non-transitory computer-readable medium described herein, the second subband may be allocated for a limited use of CETs by only UEs.

In some examples of the method, UEs, and non-transitory computer-readable medium described herein, the second subband may be allocated for exclusive use within the licensed spectrum.

Some examples of the method, UEs, and non-transitory computer-readable medium described herein may further include operations, features, means, or instructions for determining that the wireless communications on the outdoor network deployment may be associated with a first subband of the overlapping frequency band, a second subband of the overlapping frequency band, and a third subband of the overlapping frequency band, where the first subband may be allocated for exclusive use within the licensed spectrum, the second subband may be allocated for shared use by network entities and UEs, and the third subband may be allocated for shared use by UEs.

In some examples of the method, UEs, and non-transitory computer-readable medium described herein, the first subband may be time division duplexed or full duplexed.

In some examples of the method, UEs, and non-transitory computer-readable medium described herein, the second subband may be allocated for CETs by a network entity or for LBT-based communications by the UE or for certain types of duty cycle CETs by the UE.

In some examples of the method, UEs, and non-transitory computer-readable medium described herein, the third subband may be allocated for LBT-based communications by the UE and the third subband may be not accessible by network entities, in accordance with the one or more rules.

Some examples of the method, UEs, and non-transitory computer-readable medium described herein may further include operations, features, means, or instructions for performing an LBT procedure according to a spatial parameter prior to accessing a first subband of the overlapping frequency band of the outdoor network deployment, in accordance with the one or more rules.

### BRIEF DESCRIPTION OF THE DRAWINGS

FIG. 1 shows an example of a wireless communications system that supports frequency band sharing techniques in accordance with one or more aspects of the present disclosure.

FIG. 2 shows an example of a wireless communications system that supports frequency band sharing techniques in accordance with one or more aspects of the present disclosure.

FIGS. 3A-3B show examples of a duplexing scheme that supports frequency band sharing techniques in accordance with one or more aspects of the present disclosure.

FIGS. 4A-4B show examples of a duplexing scheme that supports frequency band sharing techniques in accordance with one or more aspects of the present disclosure.

FIG. 5 shows an example of a duplexing scheme that supports frequency band sharing techniques in accordance with one or more aspects of the present disclosure.

FIGS. 6 and 7 show block diagrams of devices that support frequency band sharing techniques in accordance with one or more aspects of the present disclosure.

FIG. 8 shows a block diagram of a communications manager that supports frequency band sharing techniques in accordance with one or more aspects of the present disclosure.

FIG. 9 shows a diagram of a system including a device that supports frequency band sharing techniques in accordance with one or more aspects of the present disclosure.

FIGS. 10 through 12 show flowcharts illustrating methods that support frequency band sharing techniques in accordance with one or more aspects of the present disclosure.

### DETAILED DESCRIPTION

Wireless networks may operate in different frequency bands. Further, parts of a given frequency band may be allocated or otherwise used for specific functions and/or in particular scenarios. For example, in some scenarios the frequency band may be allocated for unlicensed users. Other scenarios may allocate the frequency band for licensed users. Such networks, however, may not provide a means for different allocations to coexist together in a meaningful and efficient manner.

Accordingly, aspects of the described techniques provide for coexistence for a frequency band allocated to different deployment scenarios. For example, the frequency band may be allocated to an unlicensed spectrum for indoor deployment scenarios. The indoor deployment of the unlicensed spectrum may utilize a time-based duplexing scheme (e.g., time division duplexing (TDD)). The frequency band may also be allocated to a licensed spectrum for outdoor deployment scenarios. The outdoor deployment of the licensed spectrum may, in contrast, use a frequency-based duplexing scheme (e.g., frequency division duplexing/subband full-duplex (FDD/SBFD)). Thus, the outdoor network may overlap with respect to the indoor network. In some examples, the network entity may access the licensed spectrum in the outdoor deployment without performing a listen-before-talk (LBT) procedure. The user equipment (UE) may use the LBT procedure when accessing the licensed spectrum in the outdoor deployment.

Aspects of the disclosure are initially described in the context of wireless communications systems. Aspects of the disclosure are further illustrated by and described with reference to apparatus diagrams, system diagrams, and flowcharts that relate to frequency band sharing techniques.

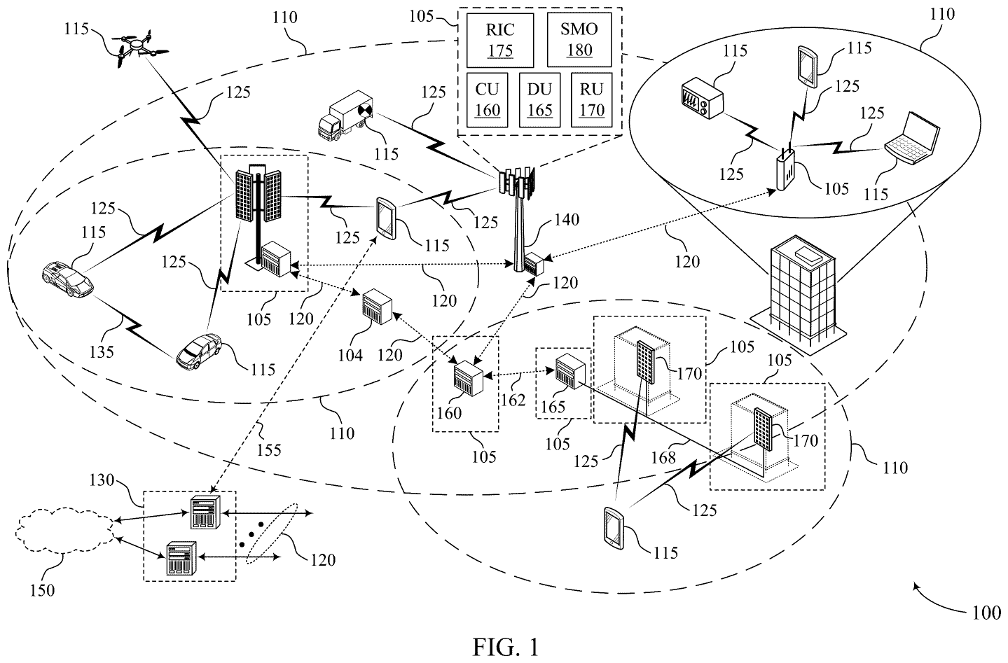

FIG. 1 shows an example of a wireless communications system 100 that supports frequency band sharing techniques in accordance with one or more aspects of the present disclosure. The wireless communications system 100 may include one or more network entities 105, one or more UEs 115, and a core network 130. In some examples, the wireless communications system 100 may be a Long-Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support frequency band sharing techniques as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both FDD and TDD component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may receive an indication of one or more rules for wireless communications on an outdoor network deployment using a licensed spectrum that includes an overlapping frequency band with respect to an unlicensed spectrum used for wireless communications on an indoor network, wherein the one or more rules facilitate coexistence between the indoor network and the outdoor network deployment. The UE 115 may perform the wireless communications on the outdoor network deployment in accordance with the one or more rules.

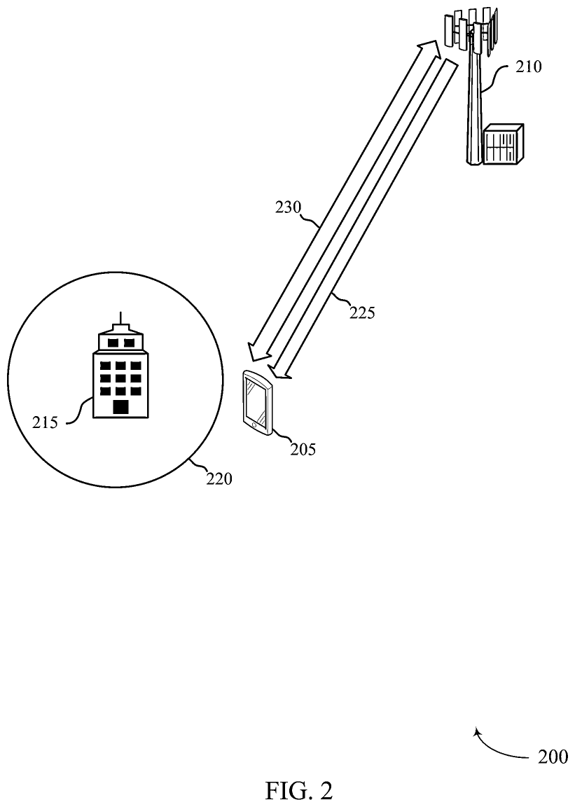

FIG. 2 shows an example of a wireless communications system 200 that supports frequency band sharing techniques in accordance with one or more aspects of the present disclosure. Wireless communications system 200 may implement aspects of wireless communications system 100. Wireless communications system 200 may include a UE 205 and/or a network entity 210, which may be examples of the corresponding devices described herein. Wireless communications system 200 may further include an indoor network 215 with a corresponding coverage area 220, which may be an example of a cellular or non-cellular-based wireless network operating within an indoor deployment scenario.

Wireless communications system 200 may utilize various frequency resources to support wireless communications between wireless nodes of the network. The UE 205 and/or network entity 210 may use various channels in the sub-6 GHz range and/or in the 6+ GHz range for wireless communications. The network entity 210 may be considered an outdoor network deployment in that the network entity 210 is deployed outdoors and provides wireless coverage to a geographical area, such as the geographical area in which the UE 205 is located.

The indoor network 215 may be an indoor Wi-Fi network, an indoor cellular network, or other wireless network that may operate in or near the same frequency range as the outdoor network provided by the network entity 210. The indoor network 215 may considered an indoor network in that the AP and/or a cell located inside a structure (e.g., a building, as shown in this non-limiting example) provides wireless service to nodes located within or near the structure. This may include nodes operating within the corresponding coverage area 220 performing wireless communications with the AP and/or cell located inside the structure.

In some examples, the outdoor network and indoor network deployments may have overlapping coverage areas. For example, the indoor network 215 and corresponding coverage area 220 may be located within the some or all of the coverage area provided by the network entity 210. Accordingly, in some situations the nodes (e.g., the UE 205) of the outdoor network may be located proximate to the indoor network 215 (e.g., within a threshold geographical range) or may be located within the indoor network 215 (e.g., inside the structure, but communicating via the outdoor network) such that there may be interference between the indoor network and the outdoor network.

Moreover, in some examples the indoor network 215 and outdoor network may be operating in the same or overlapping frequency band(s). For example, the indoor network 215 and the outdoor network deployment provided by the network entity 210 may be operating in or otherwise share an upper portion of the 6 GHz frequency band or a different frequency band. In some deployment scenarios, this may include the overlapping frequency band being allocated or otherwise assigned to be used as an unlicensed spectrum for the indoor network 215. For example, the indoor network 215 may be using the overlapping frequency band for shared or unlicensed communications between the wireless nodes. Operating in an unlicensed spectrum generally includes a wireless device performing a LBT, CCA, or other contention-based procedure prior to accessing the unlicensed spectrum. The device may monitor the channel to be accessed to ensure that the channel is free and available for use before occupying the channel.

In some aspects, the indoor network 215 may use a time-based duplexing scheme, such as TDD. The unlicensed spectrum deployments (such as the indoor network 215) may be TDD deployments where the AP and/or wireless stations take turns occupying the medium based on the contention-based mechanisms.

The outdoor network deployment provided by the network entity 210 may use a frequency spectrum allocated or otherwise assigned to licensed communications. For example, the network entity 210 may manage aspects of scheduling and/or allocating resources for the wireless communications with the UE 205. The outdoor network deployment provided by the network entity 210 may also use TDD techniques, in some examples, where the network entity 210 and the UE 205 take turns transmitting and receiving based on the schedule determined by the network entity 210.

However, in the deployment scenario where the indoor network 215 and the outdoor network deployment share some or all of the same overlapping frequency band, the interference between wireless networks may disrupt communications. For example, the UE 205 located proximate to the indoor network 215 may experience excessive interference when the indoor network 215 and the outdoor network use the overlapping frequency band.

Accordingly, aspects of the techniques described herein provide various rules for improved coexistence between the indoor network 215 and the outdoor network deployment provided by the network entity 210. The provided rules enable the indoor network 215 to operate in the unlicensed spectrum using the TDD duplexing scheme and the outdoor network to operate in the licensed spectrum using a TDD duplexing scheme and/or using a frequency-based duplexing scheme (e.g., FDD and/or SBFD). The rules may generally define an LBT scheme and/or a duplexing scheme to be applied for communications in the licensed spectrum of the outdoor network deployment provided by the network entity 210.

At 225, this may include the network entity 210 transmitting or otherwise providing (and the UE 205 receiving or otherwise obtaining) an indication of rule(s) for wireless communications on the outdoor network deployment using the licensed spectrum. These rule(s) may provide for the indoor network 215 to use the overlapping frequency band as an unlicensed spectrum (e.g., relying on LBT) while also providing for the outdoor network deployment provided by the network entity 210 to use the overlapping frequency band as a licensed spectrum (e.g., generally network-managed channel access).

At 230, the UE 205 and the network entity 210 may perform the wireless communications on the outdoor network deployment according to the rule(s). In some examples, the rule(s) may define an LBT scheme to be applied to the wireless communications. For example, the LBT scheme include or otherwise define the UE 205 performing an LBT procedure prior to accessing the licensed spectrum of the outdoor network deployment. That is, some examples of the rule(s) may include the UE 205 and/or the network entity 210 accessing the licensed spectrum of the outdoor network using a contention-based mechanism. This may permit the UE 205 to identify or otherwise determine whether wireless communications using the unlicensed spectrum of the indoor network 215 would interfere with the uplink communications to the network entity 210 using the licensed spectrum of the outdoor network.

The rule(s) may further provide or otherwise define a duplexing scheme to be applied to the wireless communications in the licensed spectrum of the outdoor network deployment provided by the network entity 210. In some examples, this may include the licensed spectrum of the outdoor network deployment utilizing frequency based duplexing schemes. For example, the outdoor network deployment may divide the overlapping frequency band into multiple subbands, with at least one subband being a downlink subband and at least one subband being an uplink subband. The downlink subband may be used by the network entity 210 for downlink transmissions to the UE 205 and the uplink subband may be used by the UE 205 for uplink transmissions to the network entity 210.

In some examples, the UE 205 may perform an LBT procedure before accessing and/or otherwise transmitting to the uplink subband for the uplink transmissions. In contrast, the network entity 210 may not perform an LBT procedure prior to performing the downlink transmissions. That is, in some aspects the licensed deployment use of the spectrum may include non LBT procedure prior to transmission from the outdoor transmitter (e.g., the network entity 210), where the LBT procedure may be used prior to transmission from the transmitter that might be indoors (e.g., the UE 205, which may be located proximate to the indoor network 215).

In some examples of the techniques described herein, the LBT scheme discussed herein may be based on the antenna selectivity requirements of the transmitting node. For example, each UE may be using different spatial parameters for transmissions such that the spatial parameter may be considered when determining whether the LBT procedure is to be performed (e.g., according to the rules). For example, an LBT requirement per-subband may also be a function of the antenna selectivity. More selective transmission (e.g., narrow spatial beams) may be exempt from performing the LBT procedure before channel access. The selectivity threshold for CETs (e.g., exemption from the LBT procedure) may be a function of the subband within the overlapping frequency band being used for the wireless communications.

Thus, the rule(s) provide a mechanism for the outdoor network deployment provided by the network entity 210 to coexist with the indoor network 215 by managing or otherwise mitigating interference between the networks. The rule(s) provide various schemes that permit the UE 205 located proximate to the indoor network 215 to monitor the channel for indoor network traffic prior to accessing the licensed channel for communications with the network entity 210.

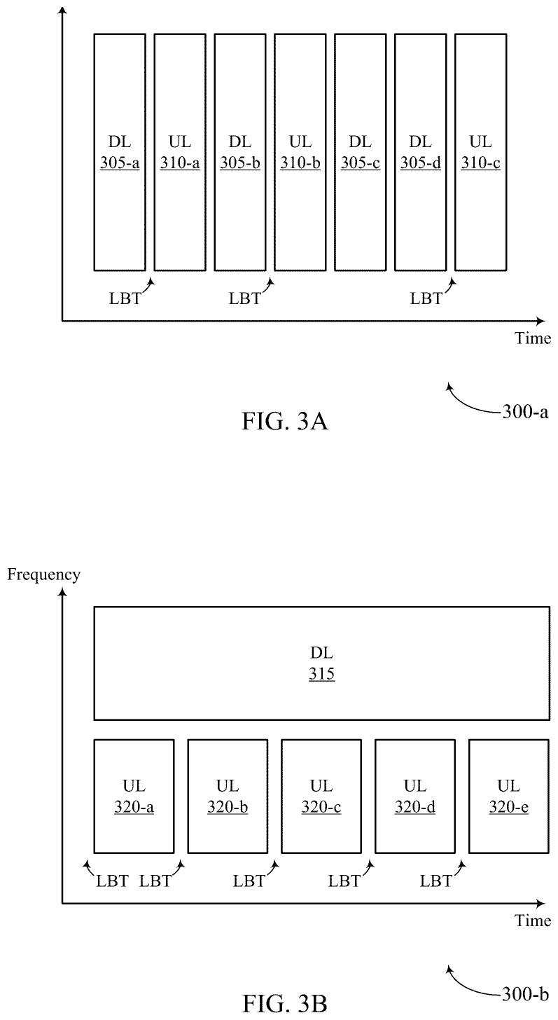

FIGS. 3A-3B show examples of a duplexing scheme 300 that supports frequency band sharing techniques in accordance with one or more aspects of the present disclosure. Duplexing scheme 300 may implement aspects of wireless communications system 100 and/or wireless communications system 200. Aspects of duplexing scheme 300 may be implemented at or implemented by a UE and/or network entity, which may be examples of the corresponding devices described herein. Duplexing scheme 300-a of FIG. 3A illustrates an example of a time-based duplexing scheme and duplexing scheme 300-b of FIG. 3B illustrates an example of a frequency-based duplexing scheme.

As discussed above, aspects of the techniques described herein provide for rule(s) that may be configured within an outdoor network deployment provided by a network entity to support or otherwise facilitate coexistence with an indoor network using an overlapping frequency band. The rule(s) may be indicated to the UE for wireless communications on the outdoor network (e.g., via RRC signaling, medium access control-control element (MAC-CE) signaling, and/or via other signaling means). The indoor and outdoor networks may share an overlapping frequency band (e.g., fully or partially overlapping frequency resources). The overlapping frequency band may be assigned or otherwise used as an unlicensed spectrum for the indoor network but may be assigned or otherwise used as a licensed spectrum for the outdoor network.

The rule(s) indicated to the UE may generally define an LBT scheme and/or a duplexing scheme to be applied for communications in the licensed spectrum of the outdoor network that avoid or mitigate interference between the indoor network and the outdoor network. Duplexing scheme 300 illustrates non-limiting examples of both LBT and duplexing schemes used for performing wireless communications in the licensed spectrum of the outdoor network deployment in a manner that mitigates or eliminates interference between the indoor and outdoor networks.

Turning first to duplexing scheme 300-a of FIG. 3A, illustrated therein is a time-based duplexing scheme (e.g., TDD) to be applied for the wireless communications in the outdoor network deployment provided by the network entity. For example, the UE and/or network entity may identify or otherwise determine that the wireless communications on the outdoor network are TDD that include downlink transmission time durations 305 and uplink transmission time durations 310. In the non-limiting example illustrated in FIG. 3A, this may include downlink transmission time duration 305-a, uplink transmission time duration 310-a, downlink transmission time duration 305-b, uplink transmission time duration 310-b, downlink transmission time duration 305-c, downlink transmission time duration 305-d, and uplink transmission time duration 310-c. However, it is to be understood that different configurations of transmission time durations may be used in accordance with the techniques described herein. Based on the time-based duplexing scheme shown in FIG. 3A, the entire overlapping frequency band may be used by the network entity and the UE.

In some aspects, the rule(s) indicated to the UE may further define an LBT scheme that includes the UE performing an LBT procedure prior to transmitting to the outdoor network deployment. For example, the UE may perform the LBT procedure prior to accessing the frequency band during any instance of the uplink transmission time duration 310. The LBT scheme may further define that the network entity does not perform the LBT procedure priori to wireless communications during any instance of the downlink transmission time duration 305. That is, the TDD duplexing scheme shown in FIG. 3A may be defined (e.g., according to the rule(s)) such that the network entity (e.g., being an outdoor deployment, having a high effective isotropic radiated power (EIRP), and the like) does not perform the LBT procedure prior to accessing the frequency band during downlink transmission time durations 305 but the UE (e.g., mobile deployment, low EIRP, and the like) does perform the LBT procedure prior to accessing the frequency band during uplink transmission time durations 310.

Turning next to duplexing scheme 300-b of FIG. 3B, illustrated therein is a frequency-based duplexing scheme to be applied for the wireless communications in the outdoor network deployment provided by the network entity. For example, the UE and/or network entity may identify or otherwise determine that the wireless communications on the outdoor network are associated with a first subband (e.g., uplink subband 320) of the overlapping frequency band and a second subband (e.g., downlink subband 315) of the overlapping frequency band. That is, the first subband may include uplink subband 320 used for uplink transmissions from the UE to the network entity where the second subband may include the downlink subband 315 used for downlink transmissions from the network entity to the UE.

Thus, duplexing scheme 300-b illustrates a non-limiting example where the licensed spectrum of the outdoor network deployment uses a frequency-based duplexing scheme (e.g., FDD) to support coexistence with a TDD-based indoor network using an overlapping band allocated as an unlicensed spectrum for the indoor network.

In some aspects, the rule(s) indicated to the UE may further define an LBT scheme that includes the UE performing an LBT procedure prior to accessing and/or transmitting to the outdoor network deployment. The UE may perform the LBT procedure prior to accessing the uplink subband 320 during any instance of the uplink transmission time durations. That is, the UE may perform an LBT procedure prior to accessing the uplink subband 320-a during a first uplink transmission time duration, prior to accessing the uplink subband 320-b during a second uplink transmission time duration, prior to accessing the uplink subband 320-c during a third uplink transmission time duration, prior to accessing the uplink subband 320-d during a fourth uplink transmission time duration, and/or prior to accessing the uplink subband 320-e during a fifth uplink transmission time duration.

The LBT scheme may further define that the network entity does not perform the LBT procedure priori to wireless communications on the downlink subband 315. That is, the FDD duplexing scheme shown in FIG. 3B may be defined (e.g., according to the rule(s)) such that the network entity (e.g., being an outdoor deployment, having a high EIRP, and the like) does not perform the LBT procedure prior to accessing the downlink subband 315 but the UE (e.g., mobile deployment, low EIRP, and the like) does perform the LBT procedure prior to accessing the uplink subband 320. In this example, there may be no overlap between the downlink subband 315 used by the network entity and the uplink subband 320 used by the UE.

Accordingly, in some aspects the LBT procedure (e.g., the LBT scheme) applied during the wireless communications in the licensed spectrum of the outdoor network deployment may be based on the subband being used (e.g., downlink subband 315 or uplink subband 320) and/or based on the node performing the wireless communications (e.g., whether a UE or network entity is performing the wireless communications).

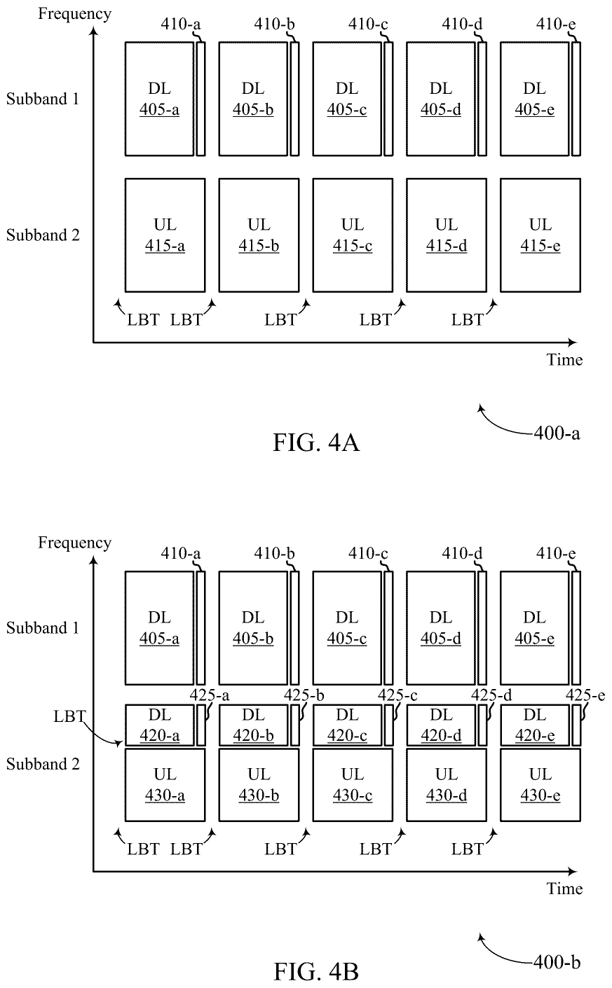

FIGS. 4A-4B show examples of a duplexing scheme 400 that supports frequency band sharing techniques in accordance with one or more aspects of the present disclosure. Duplexing scheme 400 may implement aspects of wireless communications system 100 and/or wireless communications system 200 and/or aspects of duplexing scheme 300. Aspects of duplexing scheme 400 may be implemented at or implemented by a UE and/or network entity, which may be examples of the corresponding devices described herein. Duplexing scheme 400-a of FIG. 4A illustrates an example of a first frequency-based duplexing scheme and duplexing scheme 400-b of FIG. 4B illustrates an example of a second frequency-based duplexing scheme.

As discussed above, aspects of the techniques described herein provide for rule(s) that may be configured within an outdoor network deployment provided by a network entity to support or otherwise facilitate coexistence with an indoor network using an overlapping frequency band. The rule(s) may be indicated to the UE for wireless communications on the outdoor network (e.g., via RRC signaling, MAC-CE signaling, and/or via other signaling means). The indoor and outdoor networks may share an overlapping frequency band (e.g., fully or partially overlapping frequency resources). The overlapping frequency band may be assigned or otherwise used as an unlicensed spectrum for the indoor network but may be assigned or otherwise used as a licensed spectrum for the outdoor network.

The rule(s) indicated to the UE may generally define an LBT scheme and/or a duplexing scheme to be applied for communications in the licensed spectrum of the outdoor network that avoid or mitigate interference between the indoor network and the outdoor network. Duplexing scheme 400 illustrates non-limiting examples of both LBT and duplexing schemes used for performing wireless communications in the licensed spectrum of the outdoor network deployment in a manner that mitigates or eliminates interference between the indoor and outdoor networks.

Turning first to duplexing scheme 400-a of FIG. 4A, illustrated therein is a frequency based duplexing scheme where the overlapping frequency band is divided into two subbands. For example, the overlapping frequency band may be divided into a first subband (e.g., subband 1) that includes downlink subband 405 and a second subband (e.g., subband 2) that includes uplink subband 415. A portion of the downlink transmission time durations allocated to the downlink subband 405 may be allocated to uplink control transmissions using an uplink subband 410. That is, the first subband may be both frequency duplexed as well as time duplexed such that the uplink subband 410 occupies at least a portion of the transmission time durations of the downlink subband 405.

This may include downlink subband 405-a, uplink subband 410-a, and uplink subband 415-a during a first transmission time duration, downlink subband 405-b, uplink subband 410-b, and uplink subband 415-b during a second transmission time duration, downlink subband 405-c, uplink subband 410-c, and uplink subband 415-c during a third transmission time duration, downlink subband 405-d, uplink subband 410-d, and uplink subband 415-d during a fourth transmission time duration, and downlink subband 405-e, uplink subband 410-e, and uplink subband 415-e during a fifth transmission time duration.

One example of the LBT scheme defined by the rule(s) may include the first subband (e.g., downlink subband 405) being used for communications that do not require the LBT procedure, but the second subband (e.g., uplink subband 415) being used for communications do require the LBT procedure to be performed.

That is, in some examples the licensed deployment use of the spectrum may include the first subband being configured or otherwise allocated (e.g., according to the rule(s)) to allow clear channel assessment (CCA)-exempt transmissions (CETs) by the UE and/or the network entity. In some examples, the first subband may be an exclusively licensed subband such that the first subband is allocated for exclusive use within the licensed spectrum. In some examples, the first subband may be configured such that the network entity may perform CETs but the UE may perform limited transmissions according to a duty cycle of the transmissions of the UE (or aggregate of UEs or all UEs). That is, the first subband may be allocated for CETs from the network entity and for type(s) of duty cycle transmissions from the UE.

For the second subband, in some examples all nodes (e.g., UE and/or network entity) performing wireless communications in the second subband (e.g., uplink subband 415) may be allocated or otherwise configured for CETs. In some examples, the second subband may be allocated or otherwise configured for limited use CETs by the UE and/or by the network entity. That is, the CET may be allowed for a limited amount of time for UEs, network entities, or both, in the second subband. In some examples, the second subband may be allocated or otherwise configure or limited use CETs by the UE only. In yet another example, the second subband may be allocated or otherwise assigned for exclusive use within the licensed spectrum (e.g., an exclusively licensed subband).

Turning next to duplexing scheme 400-b of FIG. 4B, illustrated therein is a frequency based duplexing scheme where the overlapping frequency band is divided into two subbands. For example, the overlapping frequency band may be divided into a first subband (e.g., subband 1) that includes downlink subband 405 and a second subband (e.g., subband 2). The second subband has been further divided and includes downlink subband 420 and uplink subband 430. A portion of the downlink transmission time durations allocated to the downlink subband 405 may be allocated to uplink control transmissions using an uplink subband 410. That is, the first subband may be both frequency duplexed as well as time duplexed such that the uplink subband 410 occupies at least a portion of the transmission time durations of the downlink subband 405.

Similarly, a portion of the downlink transmission time durations allocated to the downlink subband 420 may be allocated to uplink control transmissions using an uplink subband 425. That is, a portion of the second subband may be both frequency duplexed as well as time duplexed such that the uplink subband 425 occupies at least a portion of the transmission time durations of the downlink subband 420.

This may include downlink subband 405-a, uplink subband 410-a, downlink subband 420-a, uplink subband 425-a, and uplink subband 430-a during a first transmission time duration, downlink subband 405-b, uplink subband 410-b, downlink subband 420-b, uplink subband 425-b, and uplink subband 430-b during a second transmission time duration, downlink subband 405-c, uplink subband 410-c, downlink subband 420-c, uplink subband 425-c, and uplink subband 430-c during a third transmission time duration, downlink subband 405-d, uplink subband 410-d, downlink subband 420-d, uplink subband 425-d, and uplink subband 430-d during a fourth transmission time duration, and downlink subband 405-c, uplink subband 410-c, downlink subband 420-c, uplink subband 425-c, and uplink subband 430-e during a fifth transmission time duration.

In some aspects, the duplexing scheme 400-b illustrates a non-limiting example of a frequency-based duplexing scheme where the overlapping frequency band is divided into two subbands, with the second subband being further divided into downlink and uplink subbands. The LBT scheme applied according to the rules may be similar to those described with respect to duplexing scheme 400-a. However, in this example a wireless node (e.g., the network entity and/or UE) accessing the downlink subband 420 of the second subband may perform an LBT procedure prior to accessing the licensed spectrum of the outdoor network deployment.

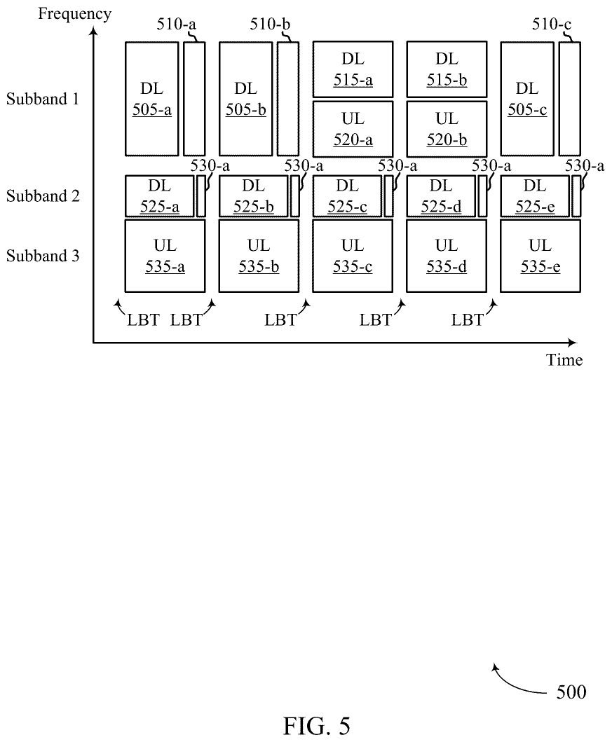

FIG. 5 shows an example of a duplexing scheme 500 that supports frequency band sharing techniques in accordance with one or more aspects of the present disclosure. Duplexing scheme 500 may implement aspects of wireless communications system 100 and/or wireless communications system 200 and/or aspects of duplexing scheme 300 and/or duplexing scheme 400. Aspects of duplexing scheme 500 may be implemented at or implemented by a UE and/or network entity, which may be examples of the corresponding devices described herein. Duplexing scheme 500 illustrates an example of a first frequency-based duplexing scheme based on the overlapping frequency spectrum band being divided into three subbands.

As discussed above, aspects of the techniques described herein provide for rule(s) that may be configured within an outdoor network deployment provided by a network entity to support or otherwise facilitate coexistence with an indoor network using an overlapping frequency band. The rule(s) may be indicated to the UE for wireless communications on the outdoor network. The indoor and outdoor networks may share an overlapping frequency band. The overlapping frequency band may be assigned or otherwise used as an unlicensed spectrum for the indoor network but may be assigned or otherwise used as a licensed spectrum for the outdoor network.

The rule(s) indicated to the UE may generally define an LBT scheme and/or a duplexing scheme to be applied for communications in the licensed spectrum of the outdoor network that avoid or mitigate interference between the indoor network and the outdoor network. Duplexing scheme 500 illustrates a non-limiting example of both LBT and duplexing schemes used for performing wireless communications in the licensed spectrum of the outdoor network deployment in a manner that mitigates or eliminates interference between the indoor and outdoor networks.

The overlapping frequency band may be divided into a first subband (e.g., subband 1) that includes downlink subband 505, a second subband (e.g., subband 2) that includes downlink subband 525, and a third subband that includes uplink subband 535. A portion of some or all of the downlink transmission time durations allocated to the downlink subband 505 may be allocated to uplink control transmissions using an uplink subband 510. Moreover, the first subband may be further subdivided during some or all of the downlink transmission time durations into downlink subband 515 and uplink subband 520. A portion of some or all of the downlink transmission time durations of downlink subband 525 may also be allocated to uplink control transmissions using an uplink subband 530.

This may include downlink subband 505-a, uplink subband 510-a, downlink subband 525-a, uplink subband 530-a, and uplink subband 535-a during a first transmission time duration, downlink subband 505-b, uplink subband 510-b, downlink subband 525-b, uplink subband 530-b, and uplink subband 535-b during a second transmission time duration, downlink subband 515-a, uplink subband 520-a, downlink subband 525-c, uplink subband 530-c, and uplink subband 535-c during a third transmission time duration, downlink subband 515-b, uplink subband 520-b, downlink subband 525-d, uplink subband 530-d, and uplink subband 535-d during a fourth transmission time duration, and downlink subband 505-c, uplink subband 510-c, downlink subband 525-e, uplink subband 530-e, and uplink subband 535-e during a fifth transmission time duration.

Thus, duplexing scheme 500 illustrates a non-limiting example of the duplexing scheme including frequency-based duplexing where the overlapping frequency band is divided into multiple subband, and some or all of the subbands may further be subdivided into time-based and/or frequency-based duplexing schemes (e.g., TDD/FDD/SBFD). This flexibility in configuring or otherwise allocating the overlapping frequency band may support improved coexistence with the indoor network operating in the same overlapping frequency band.

Different LBT schemes may be applied according to the duplexing scheme 500. One LBT scheme may include the UE and/or network entity identifying or otherwise determining that the first subband is allocated or otherwise assigned for exclusive use within the licensed spectrum (e.g., either TDD or SBFD), the second subband is allocated or otherwise assigned for shared use by network entities and UEs (e.g., with possibly low duty cycle CETs being allowed), and the third subband being allocated or otherwise assigned for shared use by the UEs. That is, the second subband may be a shared subband with the network entity using CETs and the UEs performing the LBT procedure before access (e.g., with low duty cycle CETs). The third subband may be a shared subband with the UEs performing the LBT procedure where the network entities are not configured to access the third subband.

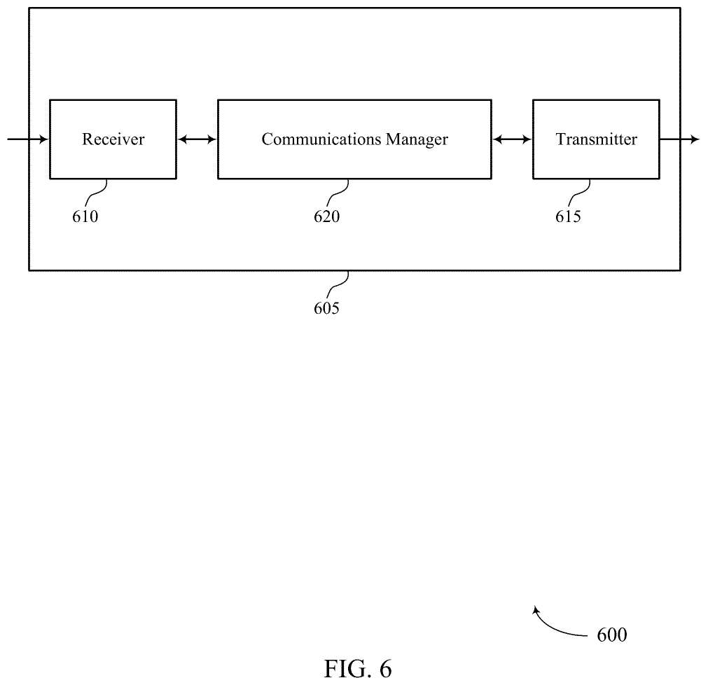

FIG. 6 shows a block diagram 600 of a device 605 that supports frequency band sharing techniques in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include one or more processors, memory coupled with the one or more processors, and instructions stored in the memory that are executable by the one or more processors to enable the one or more processors to perform the shared spectrum coexistence features discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to frequency band sharing techniques). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to frequency band sharing techniques). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of frequency band sharing techniques as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The communications manager 620 is capable of, configured to, or operable to support a means for performing the wireless communications on the outdoor network deployment in accordance with the one or more rules.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improved coexistence rules applied by an outdoor network deployment operating in an overlapping frequency band with an indoor network. The rules may define duplexing and/or LBT schemes to be applied by the UE and/or network entity when performing wireless communications in the licensed spectrum of the outdoor network using an overlapping frequency band with the indoor network.

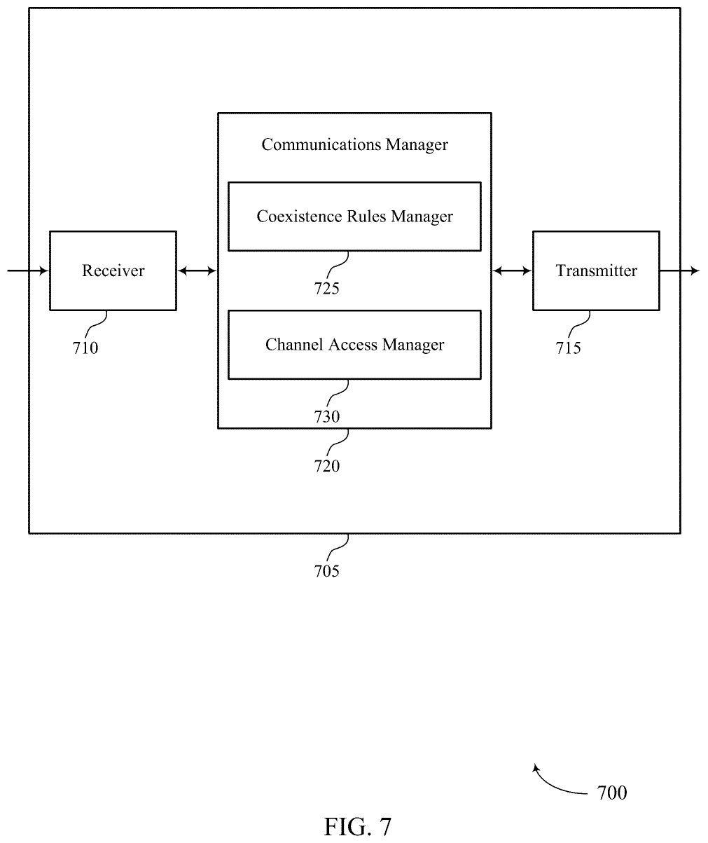

FIG. 7 shows a block diagram 700 of a device 705 that supports frequency band sharing techniques in accordance with one or more aspects of the present disclosure. The device 705 may be an example of aspects of a device 605 or a UE 115 as described herein. The device 705 may include a receiver 710, a transmitter 715, and a communications manager 720. The device 705, or one of more components of the device 705 (e.g., the receiver 710, the transmitter 715, and the communications manager 720), may include one or more processors, memory coupled with the one or more processors, and instructions stored in the memory that are executable by the one or more processors to enable the one or more processors to perform the shared spectrum coexistence features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to frequency band sharing techniques). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to frequency band sharing techniques). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of frequency band sharing techniques as described herein. For example, the communications manager 720 may include a coexistence rules manager 725 a channel access manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The coexistence rules manager 725 is capable of, configured to, or operable to support a means for receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The channel access manager 730 is capable of, configured to, or operable to support a means for performing the wireless communications on the outdoor network deployment in accordance with the one or more rules.

In some cases, the coexistence rules manager 725 and the channel access manager 730 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the coexistence rules manager 725 and the channel access manager 730 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

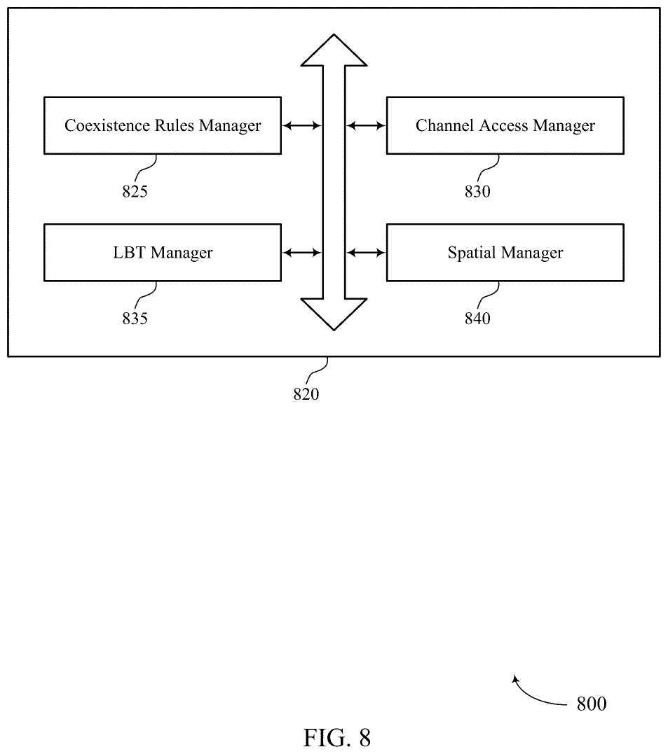

FIG. 8 shows a block diagram 800 of a communications manager 820 that supports frequency band sharing techniques in accordance with one or more aspects of the present disclosure. The communications manager 820 may be an example of aspects of a communications manager 620, a communications manager 720, or both, as described herein. The communications manager 820, or various components thereof, may be an example of means for performing various aspects of frequency band sharing techniques as described herein. For example, the communications manager 820 may include a coexistence rules manager 825, a channel access manager 830, an LBT manager 835, a spatial manager 840, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The coexistence rules manager 825 is capable of, configured to, or operable to support a means for receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The channel access manager 830 is capable of, configured to, or operable to support a means for performing the wireless communications on the outdoor network deployment in accordance with the one or more rules.

In some examples, the outdoor network using the licensed spectrum comprises at least one of a TDD network, a FDD network, or a SBFD network. In some examples, a first subband of the SBFD network is used for uplink communications based on a LBT procedure and a second subband of the SBFD network is used for downlink communications without the LBT procedure. In some examples, the indoor network using the unlicensed network comprises a different TDD network where the UE is in a non-connected state.

In some examples, to support performing the wireless communications on the outdoor network deployment, the LBT manager 835 is capable of, configured to, or operable to support a means for performing an LBT procedure prior to transmitting to the outdoor network deployment, in accordance with the one or more rules.

In some examples, the LBT manager 835 is capable of, configured to, or operable to support a means for determining that the wireless communications on the outdoor network deployment are time division duplexed to include uplink transmission time durations and downlink transmission time durations, and where the LBT procedure, in accordance with the one or more rules, occurs prior to wireless communications during the uplink transmission time durations but not prior to wireless communications during the downlink transmission time durations.

In some examples, the LBT manager 835 is capable of, configured to, or operable to support a means for determining that the wireless communications on the outdoor network deployment are associated with a first subband of the overlapping frequency band and a second subband of the overlapping frequency band, where the first subband is allocated for uplink communications and the second subband is allocated for downlink communications, where the LBT procedure is based on the first subband in accordance with the one or more rules. In some examples, the LBT procedure is based on the UE, in accordance with the one or more rules.

In some examples, the LBT manager 835 is capable of, configured to, or operable to support a means for determining that the wireless communications on the outdoor network deployment are associated with a first subband of the overlapping frequency band and a second subband of the overlapping frequency band, where the first subband is allocated for wireless communications that do not require the LBT procedure, and the second subband is allocated for wireless communications that do require the LBT procedure.

In some examples, the first subband is allocated for CETs by the UE. In some examples, the first subband is allocated for exclusive use within the licensed spectrum. In some examples, the first subband is allocated for CETs by a network entity and for one or more types of duty cycle transmissions of the UE. In some examples, the second subband is allocated to require the LBT procedure for any transmission over the second subband. In some examples, the second subband is allocated for a limited use of CETs by UEs and network entities. In some examples, the second subband is allocated for a limited use of CETs by only UEs. In some examples, the second subband is allocated for exclusive use within the licensed spectrum.

In some examples, the LBT manager 835 is capable of, configured to, or operable to support a means for determining that the wireless communications on the outdoor network deployment are associated with a first subband of the overlapping frequency band, a second subband of the overlapping frequency band, and a third subband of the overlapping frequency band, where the first subband is allocated for exclusive use within the licensed spectrum, the second subband is allocated for shared use by network entities and UEs, and the third subband is allocated for shared use by UEs. In some examples, the first subband is time division duplexed or full duplexed. In some examples, the second subband is allocated for CETs by a network entity or for LBT-based communications by the UE or for certain types of duty cycle CETs by the UE. In some examples, the third subband is allocated for LBT-based communications by the UE. In some examples, the third subband is not accessible by network entities, in accordance with the one or more rules.

In some examples, the spatial manager 840 is capable of, configured to, or operable to support a means for performing an LBT procedure according to a spatial parameter prior to accessing a first subband of the overlapping frequency band of the outdoor network deployment, in accordance with the one or more rules.

In some cases, the coexistence rules manager 825, the channel access manager 830, the LBT manager 835, the spatial manager 840 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the coexistence rules manager 825, the channel access manager 830, the LBT manager 835, the spatial manager 840 discussed herein.

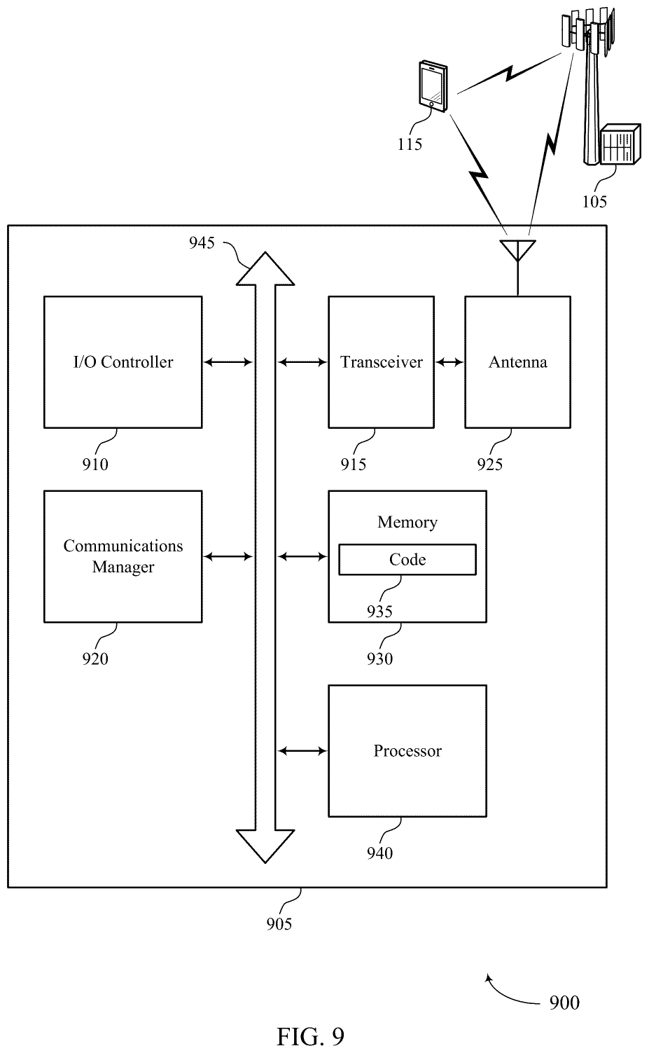

FIG. 9 shows a diagram of a system 900 including a device 905 that supports frequency band sharing techniques in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting frequency band sharing techniques). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The communications manager 920 is capable of, configured to, or operable to support a means for performing the wireless communications on the outdoor network deployment in accordance with the one or more rules.

By including or configuring the communications manager 920 in accordance with examples as described herein, the device 905 may support techniques for improved coexistence rules applied by an outdoor network deployment operating in an overlapping frequency band with an indoor network. The rules may define duplexing and/or LBT schemes to be applied by the UE and/or network entity when performing wireless communications in the licensed spectrum of the outdoor network using an overlapping frequency band with the indoor network.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of frequency band sharing techniques as described herein, or the at least one processor 940 and the at least one memory 930 may be otherwise configured to, individually or collectively, perform or support such operations.

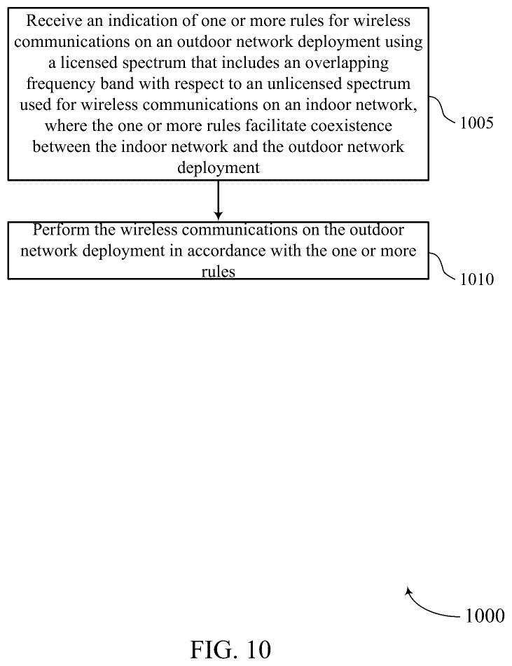

FIG. 10 shows a flowchart illustrating a method 1000 that supports frequency band sharing techniques in accordance with aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The operations of block 1005 may be performed in accordance with examples as disclosed herein. In some examples, aspects of the operations of 1005 may be performed by a coexistence rules manager 825 as described with reference to FIG. 8.

At 1010, the method may include performing the wireless communications on the outdoor network deployment in accordance with the one or more rules. The operations of block 1010 may be performed in accordance with examples as disclosed herein. In some examples, aspects of the operations of 1010 may be performed by a channel access manager 830 as described with reference to FIG. 8.

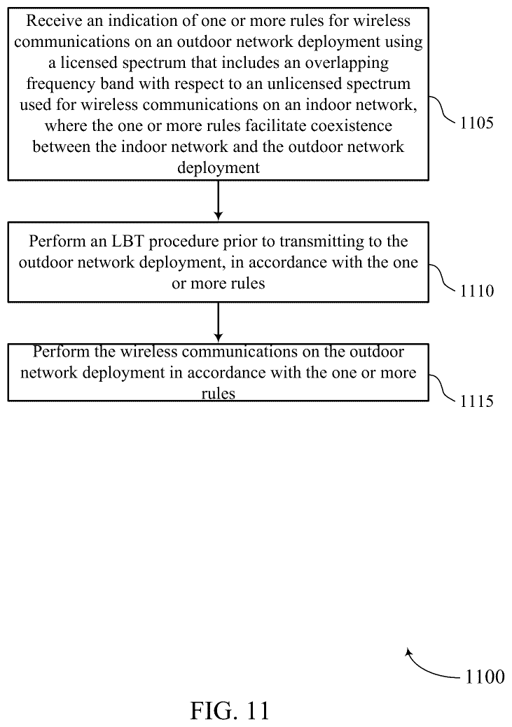

FIG. 11 shows a flowchart illustrating a method 1100 that supports frequency band sharing techniques in accordance with aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The operations of block 1105 may be performed in accordance with examples as disclosed herein. In some examples, aspects of the operations of 1105 may be performed by a coexistence rules manager 825 as described with reference to FIG. 8.

At 1110, the method may include performing an LBT procedure prior to transmitting to the outdoor network deployment, in accordance with the one or more rules. The operations of block 1110 may be performed in accordance with examples as disclosed herein. In some examples, aspects of the operations of 1110 may be performed by an LBT manager 835 as described with reference to FIG. 8.

At 1115, the method may include performing the wireless communications on the outdoor network deployment in accordance with the one or more rules. The operations of block 1115 may be performed in accordance with examples as disclosed herein. In some examples, aspects of the operations of 1115 may be performed by a channel access manager 830 as described with reference to FIG. 8.

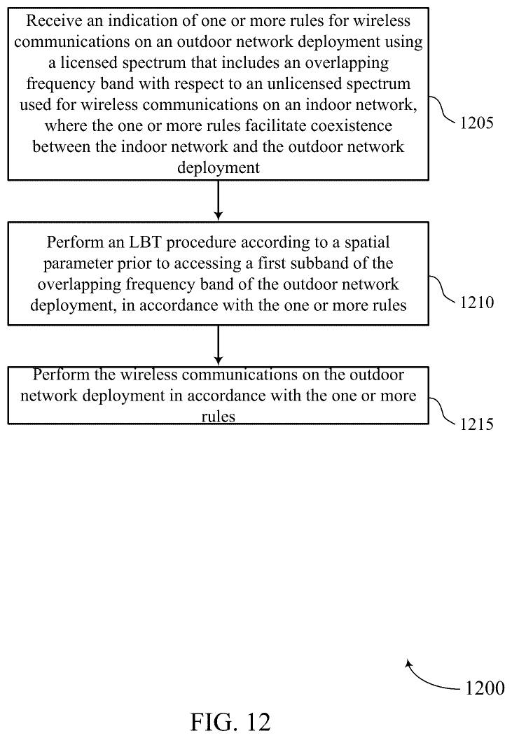

FIG. 12 shows a flowchart illustrating a method 1200 that supports frequency band sharing techniques in accordance with aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving an indication of one or more rules for wireless communications on an outdoor network deployment using a licensed spectrum that includes an overlapping frequency band with respect to an unlicensed spectrum used for wireless communications on an indoor network, where the one or more rules facilitate coexistence between the indoor network and the outdoor network deployment. The operations of block 1205 may be performed in accordance with examples as disclosed herein. In some examples, aspects of the operations of 1205 may be performed by a coexistence rules manager 825 as described with reference to FIG. 8.

At 1210, the method may include performing an LBT procedure according to a spatial parameter prior to accessing a first subband of the overlapping frequency band of the outdoor network deployment, in accordance with the one or more rules. The operations of block 1210 may be performed in accordance with examples as disclosed herein. In some examples, aspects of the operations of 1210 may be performed by a spatial manager 840 as described with reference to FIG. 8.

At 1215, the method may include performing the wireless communications on the outdoor network deployment in accordance with the one or more rules. The operations of block 1215 may be performed in accordance with examples as disclosed herein. In some examples, aspects of the operations of 1215 may be performed by a channel access manager 830 as described with reference to FIG. 8.

The following provides an overview of aspects of the present disclosure:

Aspect 1: A method for wireless communications at a UE, comprising: receiving an indication of one or more rules for wireless communications on an outdoor network deployment using a licensed spectrum that includes an overlapping frequency band with respect to an unlicensed spectrum used for wireless communications on an indoor network, wherein the one or more rules facilitate coexistence between the indoor network and the outdoor network deployment; and performing the wireless communications on the outdoor network deployment in accordance with the one or more rules.

Aspect 2: The method of aspects 1, wherein the outdoor network using the licensed spectrum comprises at least one of a TDD network, a FDD network, or a SBFD network.

Aspect 3: The method of any of aspects 1 through 2, wherein a first subband of the SBFD network is used for uplink communications based on a LBT procedure and a second subband of the SBFD network is used for downlink communications without the LBT procedure.

Aspect 4: The method of any of aspects 1 through 3, wherein the indoor network using the unlicensed network comprises a different TDD network where the UE is in a non-connected state.

Aspect 5: The method of any of aspects 1 through 4, wherein performing the wireless communications on the outdoor network deployment comprises: performing an LBT procedure prior to transmitting to the outdoor network deployment, in accordance with the one or more rules.

Aspect 6: The method of any of aspects 1 through 5, further comprising: determining that the wireless communications on the outdoor network deployment are time division duplexed to include uplink transmission time durations and downlink transmission time durations, and wherein the LBT procedure, in accordance with the one or more rules, occurs prior to wireless communications during the uplink transmission time durations but not prior to wireless communications during the downlink transmission time durations.

Aspect 7: The method of any of aspects 1 through 6, further comprising: determining that the wireless communications on the outdoor network deployment are associated with a first subband of the overlapping frequency band and a second subband of the overlapping frequency band, wherein the first subband is allocated for uplink communications and the second subband is allocated for downlink communications, wherein the LBT procedure is based on the first subband in accordance with the one or more rules.

Aspect 8: The method of any of aspects 1 through 7, wherein the LBT procedure is based on the UE, in accordance with the one or more rules.

Aspect 9: The method of any of aspects 1 through 8, further comprising: determining that the wireless communications on the outdoor network deployment are associated with a first subband of the overlapping frequency band and a second subband of the overlapping frequency band, wherein the first subband is allocated for wireless communications that do not require the LBT procedure, and the second subband is allocated for wireless communications that do require the LBT procedure.

Aspect 10: The method of any of aspects 1 through 9, wherein the first subband is allocated for CETs by the UE.

Aspect 11: The method of any of aspects 1 through 10, wherein the first subband is allocated for exclusive use within the licensed spectrum.

Aspect 12: The method of any of aspects 1 through 11, wherein the first subband is allocated for CETs by a network entity and for one or more types of duty cycle transmissions of the UE.

Aspect 13: The method of any of aspects 1 through 12, wherein the second subband is allocated to require the LBT procedure for any transmission over the second subband.

Aspect 14: The method of any of aspects 1 through 13, wherein the second subband is allocated for a limited use of CETs by UEs and network entities.

Aspect 15: The method of any of aspects 1 through 14, wherein the second subband is allocated for a limited use of CETs by only UEs.

Aspect 16: The method of any of aspects 1 through 15, wherein the second subband is allocated for exclusive use within the licensed spectrum.

Aspect 17: The method of any of aspects 1 through 16, further comprising: determining that the wireless communications on the outdoor network deployment are associated with a first subband of the overlapping frequency band, a second subband of the overlapping frequency band, and a third subband of the overlapping frequency band, wherein the first subband is allocated for exclusive use within the licensed spectrum, the second subband is allocated for shared use by network entities and UEs, and the third subband is allocated for shared use by UEs.

Aspect 18: The method of any of aspects 1 through 17, wherein the first subband is time division duplexed or full duplexed.

Aspect 19: The method of any of aspects 1 through 85, wherein the second subband is allocated for CETs by a network entity or for LBT-based communications by the UE or for certain types of duty cycle CETs by the UE.

Aspect 20: The method of any of aspects 1 through 19, wherein the third subband is allocated for LBT-based communications by the UE, and the third subband is not accessible by network entities, in accordance with the one or more rules.

Aspect 21: The method of any of aspects 1 through 20, further comprising: performing an LBT procedure according to a spatial parameter prior to accessing a first subband of the overlapping frequency band of the outdoor network deployment, in accordance with the one or more rules.

Aspect 22: A UE for wireless communications, comprising one or more memories storing processor-executable code, and one or more processors coupled with the one or more memories and individually or collectively operable to execute the code to cause the UE to perform a method of any of aspects 1 through 21.

Aspect 23: A UE for wireless communications, comprising at least one means for performing a method of any of aspects 1 through 21.

Aspect 24: A non-transitory computer-readable medium storing code for wireless communications, the code comprising instructions executable by a processor to perform a method of any of aspects 1 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively operable to execute the code to cause the UE to:
receive an indication of one or more rules for wireless communications on an outdoor network deployment using a licensed spectrum that includes an overlapping frequency band with respect to an unlicensed spectrum used for wireless communications on an indoor network, wherein the one or more rules facilitate coexistence between the indoor network and the outdoor network deployment; and
perform the wireless communications on the outdoor network deployment in accordance with the one or more rules.

2. The UE of claim 1, wherein the outdoor network using the licensed spectrum comprises at least one of a time division duplexing (TDD) network, a frequency division duplexing (FDD) network, or a subband full-duplex (SBFD) network.

3. The UE of claim 2, wherein a first subband of the SBFD network is used for uplink communications based on a listen-before-talk (LBT) procedure and a second subband of the SBFD network is used for downlink communications without the LBT procedure.

4. The UE of claim 2, wherein the indoor network using the unlicensed network comprises a different TDD network where the UE is in a non-connected state.

5. The UE of claim 1, wherein, to perform the wireless communications on the outdoor network deployment, the one or more processors are individually or collectively further configured to cause the UE to:
perform a listen-before-talk (LBT) procedure prior to transmitting to the outdoor network deployment, in accordance with the one or more rules.

6. The UE of claim 5, wherein the one or more processors are individually or collectively further configured to cause the UE to:
determine that the wireless communications on the outdoor network deployment are time division duplexed to include uplink transmission time durations and downlink transmission time durations, and wherein the LBT procedure, in accordance with the one or more rules, occurs prior to wireless communications during the uplink transmission time durations but not prior to wireless communications during the downlink transmission time durations.

7. The UE of claim 5, wherein the one or more processors are individually or collectively further configured to cause the UE to:
determine that the wireless communications on the outdoor network deployment are associated with a first subband of the overlapping frequency band and a second subband of the overlapping frequency band, wherein the first subband is allocated for uplink communications and the second subband is allocated for downlink communications, wherein the LBT procedure is based on the first subband in accordance with the one or more rules.

8. The UE of claim 5, wherein the LBT procedure is based on the UE, in accordance with the one or more rules.

9. The UE of claim 5, wherein the one or more processors are individually or collectively further configured to cause the UE to:
determine that the wireless communications on the outdoor network deployment are associated with a first subband of the overlapping frequency band and a second subband of the overlapping frequency band, wherein the first subband is allocated for wireless communications that do not require the LBT procedure, and the second subband is allocated for wireless communications that do require the LBT procedure.

10. The UE of claim 9, wherein the first subband is allocated for clear channel assessment (CCA)-exempt transmissions (CETs) by the UE.

11. The UE of claim 9, wherein the first subband is allocated for exclusive use within the licensed spectrum.

12. The UE of claim 9, wherein the first subband is allocated for clear channel assessment (CCA)-exempt transmissions (CETs) by a network entity and for one or more types of duty cycle transmissions of the UE.

13. The UE of claim 9, wherein the second subband is allocated to require the LBT procedure for any transmission over the second subband.

14. The UE of claim 9, wherein the second subband is allocated for a limited use of clear channel assessment (CCA)-exempt transmissions (CETs) by UEs and network entities.

15. The UE of claim 9, wherein the second subband is allocated for a limited use of clear channel assessment (CCA)-exempt transmissions (CETs) by only UEs.

16. The UE of claim 9, wherein the second subband is allocated for exclusive use within the licensed spectrum.

17. The UE of claim 5, wherein the one or more processors are individually or collectively further configured to cause the UE to:
determine that the wireless communications on the outdoor network deployment are associated with a first subband of the overlapping frequency band, a second subband of the overlapping frequency band, and a third subband of the overlapping frequency band, wherein the first subband is allocated for exclusive use within the licensed spectrum, the second subband is allocated for shared use by network entities and UEs, and the third subband is allocated for shared use by UEs.

18. The UE of claim 17, wherein the first subband is time division duplexed or full duplexed.

19. A method for wireless communications at a user equipment (UE), comprising:
receiving an indication of one or more rules for wireless communications on an outdoor network deployment using a licensed spectrum that includes an overlapping frequency band with respect to an unlicensed spectrum used for wireless communications on an indoor network, wherein the one or more rules facilitate coexistence between the indoor network and the outdoor network deployment; and
performing the wireless communications on the outdoor network deployment in accordance with the one or more rules.

20. A user equipment (UE) for wireless communications, comprising:
means for receiving an indication of one or more rules for wireless communications on an outdoor network deployment using a licensed spectrum that includes an overlapping frequency band with respect to an unlicensed spectrum used for wireless communications on an indoor network, wherein the one or more rules facilitate coexistence between the indoor network and the outdoor network deployment; and
means for performing the wireless communications on the outdoor network deployment in accordance with the one or more rules.
